(19) United States
(12) Patent Application Publication
(10) Pub. No.: US 2005/0038681 A1
(43) Pub. Date: Feb. 17, 2005

(54) Method, apparatus and system for pricing and selling family protector insurance

(76) Inventor: Terry Covert, Winter Park, FL (US)

Correspondence Address: EUGNE R. QUINN, JR., 4030 COOL WATER COURT, WINTER PARK, FL, 32792, US

(21) Appl. No.: 09/903,918

(22) Filed: Jul. 12, 2001

(51) Int. Cl. G06F 17/60

(52) U.S. Cl. 705/4

(57) ABSTRACT

This invention relates to a method for pricing and selling Family Protector Insurance comprising receiving information relative to the proposed purchase of Family Protector Insurance; determining the price of the Family Protector Insurance; conveying the price and policy terms to the party interested in purchasing Family Protector Insurance. The invention also relates to an apparatus capable of performing these functions.

### BACKGROUND OF THE INVENTION

1. Field of the Invention

This invention relates generally to a method and system for pricing and selling insurance.

2. Background

Over the years a number of different insurance companies (i.e., insurers) have offered various types of insurance contracts (or insurance policies as they are sometimes called), all for the purpose of protecting those individuals contracting with the insurance company (i.e., insureds) from any number of different losses, risks or perils. The term “insurance contract” is defined as a contract whereby, for an agreed upon consideration, the insurer undertakes to compensate, in the form of money or other valuable act, the insured for losses suffered or liability arising from either an unknown or contingent event, risk or peril.

The protection offered by insurers takes many forms. Two of the most popular forms of insurance have been disability insurance and life insurance.

Insurance statistics reveal that a working person is sixty (60) times more likely to become disabled than to suffer an untimely death. For that reason, disability insurance is frequently provided for individuals and business entities to provide monetary protection in the event a loved one or a key person within the business suffers a defined disability.

Individuals purchase disability insurance to protect their families in the event a spouse, parent or parents become incapable of providing for the family. In the event of the defined disability of an insured, benefits are paid to the family as designated in the contract. The monies received from a policy are generally used to provide for, among other things, daily living expenses, college fees and tuition, and maintenance necessities.

Business entities purchase insurance policies on their key employees, and partners frequently purchase policies on each other. For companies, the purpose of such insurance contracts is two-fold. First, policies provide the funds necessary to provide for the needs of very important persons who become incapable of performing his/her assigned duties. The monies are generally used to provide for, among other things, daily living expenses, college fees and tuition, and maintenance necessities. Second, policies provide the company the means to replace the disabled or deceased employee without undue economic hardship to either the company or the employee.

By placing a small premium with an insurance company, individuals and companies provide protection to their families and business associates that would otherwise not be possible. They recognize that the coverage they purchase offers the opportunity for the family or associate to survive under difficult circumstances, but with a reduction of the economic duress frequently experienced when a loved one or key business figure becomes disabled. The insurer, by pooling the premiums from many purchasers and paying out of that pool, is able to provide the monthly sums needed but otherwise unavailable.

Life insurance is utilized by individuals and business entities to provide monetary protection in the event of the death of a loved one or a key person within the business. Individuals purchase life insurance to protect their families in the event a spouse, parent or parents suffer untimely demises. In the event of the death of an insured, benefits are paid to the family as designated in the contract. The monies received from a policy are generally used to provide for, among other things, paying off mortgages, daily living expenses, college fees and tuition, and maintenance necessities.

Business entities purchase insurance policies on their key employees, and partners frequently purchase policies on each other. For companies, the purpose of such insurance contracts is often to provide the funds necessary to continue the business operation after a very important person has passed away. The monies are generally used to seek out and hire a person demonstrating the skills and expertise the deceased person possessed, and without which the company would suffer.

Partners and closely held business entities frequently purchase insurance policies on their owners to provide the money necessary to purchase the deceased party's portion of the business. Those policies are generally purchased in conjunction with a purchase and sell agreement entered into by the business associates/owners.

By placing a small premium with an insurer, individuals and companies provide protection to their families and entities that would otherwise not be possible. They recognize that the coverage they purchase offers the opportunity for the family or entity to proceed under difficult circumstances, but with a reduction of the economic duress frequently experienced upon the death of a loved one or key business figure. The insurer, by pooling the premiums from many purchasers and paying out of that pool, is able to provide the monetary lump sums needed but otherwise unavailable.

Disability and life insurance are, however, certainly not the only forms of insurance available to consumers today. Some other forms of popular insurance include the following:
(1) Automobile insurance, which routinely covers the insured against loss of or damage to a motor vehicle caused by fire, windstorm, theft, collision, or other insurable hazards. Automobile insurance also routinely covers the insured against legal liability for personal injuries or damage to property resulting from operation of the vehicle.
(2) Business insurance (or key person insurance), which routinely provides life insurance benefits payable to a business upon the death or disability of a key employee.
(3) Business interruption insurance, which routinely protects a business from losses due to the inability to operate the business as a result of fire or other insurable hazards.
(4) Casualty insurance, which routinely protects against losses cause by injuries to persons and legal liability imposed upon the insured for injury or damage to the property of others.
(5) Collision insurance, which is a form of automobile insurance that covers loss to the insured vehicle from its collision with another vehicle or object, but which does not cover bodily injury or liability arising out of the collision.
(6) Commercial insurance, which is an indemnity agreement in the form of an insurance bond or policy, whereby parties to commercial contracts are to a designated extent guaranteed against loss by reason of a breach of contractual obligations on the part of the other contracting party.
(7) Employer's liability insurance, which protects the insured against liability incurred by the employer to an employee as a result of an accident, injury, or death occurring in during the course of employment.
(8) Fire insurance, which protects the insured against all losses suffered to houses, buildings, furniture, or other insured possessions, as a result of accidental fires occurring within a prescribed period.
(9) Flood insurance, which protects the insured from losses suffered as a result of flood damage.
(10) Health insurance, which is an agreement whereby an insurer is obligated to pay or allow a benefit of pecuniary value with respect to the bodily injury, disablement, sickness, death by accident or accidental means of a human being, or because of any expense relating thereto, or because of any expense incurred in prevention of sickness, and includes every risk pertaining to any of the enumerated risks set forth in the policy.
(11) Malpractice insurance, which is insurance typically carried by doctors, lawyers and other professionals to cover liability for injuries or damage caused to patients and/or clients.
(12) Mortgage insurance, which is an insurance contract from which the benefits are intended by the policy owner to pay off the balance due on a mortgage upon the death of the insured or to meet the payments on a mortgage as they fall due in case of the death or disability of the insured.
(13) Patent insurance, which is insurance against losses due to infringement of the insured's patent, or due to claim of infringement of the other's patent by the insured.
(14) Product liability insurance, which provides liability protection against claims arising out of the insured's property, conduct or the conduct of an agent.
(15) Retirement income insurance, which is a type of insurance in which the insurer guarantees payment of the policy if the insured dies before a certain age and an annuity if the insured survives beyond the specified period.
(16) Title insurance, is an insurance policy issued by a title company after searching the title, representing the state of the title and insuring the accuracy of its search against claims of title defects.
(17) Workers compensation insurance, which covers employers payments to employees who are injured in accidents arising out of and in the course of their employment.

As can be readily seen, there are a number of different types of insurance contracts available to individuals, families and businesses. Up until now, however, there has been no insurance offered by any insurer that in any way deals with a significant family and societal problem: divorce. Statistics demonstrate that in the United States there are 1,200,000 divorces per year. First marriages end in divorce 32% of the time, and subsequent marriages end in divorce 50% of the time. Additionally, 1,000,000 children each year are affect by divorce.

The dissolution of a marriage can significantly and adversely affect the financial well being of any family caught in the throngs of divorce. Nevertheless, despite the significant personal and societal difficulties presented by divorce, and despite the number and variety of insurance policies currently available, there are no insurance products currently offered that in any way protect the payee spouse in the event that the alimony paying spouse is disabled and unable to work, in the event the payor spouse dies, or in the event the payor spouse ceases making payments or makes reduced payments. Likewise, there are no insurance products currently offered that in any way protect the children of a divorced family in the event the child support paying spouse is disabled and unable to work, in the event the child support paying spouse is disabled and unable to work, or in the event the payor spouse ceases making payments or makes reduced payments.

For purposes of this application the alimony paying spouse and the child support paying spouse will sometimes be referred to as the “payor spouse.”

### SUMMARY OF THE INVENTION

The present invention advantageously fills the aforementioned deficiency in the prior art by providing a method, apparatus and system for pricing and selling Family Protector Insurance.

The present invention advantageously enables the purchaser, for an appropriate premium payment to the insurer, to purchase Family Protector Insurance, which will insure the payee spouse and/or the children of the divorced family against losses suffered due to the disability or death of the alimony and/or child support paying spouse. Family Protector Insurance may also insure the payee spouse and/or the children of the divorced family against losses suffered in the event the payor spouse ceases to make payments or makes reduced payments. This family protector insurance will guarantee that upon the disability and/or death of the payor spouse, the insurer will pay the monthly specified sum, which may be fixed or variable, to the person, persons, or entity named as beneficiary(ies) in the family protector insurance policy, pursuant to the specific terms of the policy, as determined by the divorce decree and payments ordered therein by the courts. Additionally, family protector insurance may also guarantee that upon the failure to pay, or the payment of reduced sums, by the payor spouse, the insurer will pay the monthly specified sum, which may be fixed fixed or variable, to the person, persons, or entity named as beneficiary(ies) in the family protector insurance policy, pursuant to the specific terms of the policy, as determined by the divorce decree and payments ordered therein by the courts.

Other aspects of the present invention are directed to a computer program and an apparatus corresponding to the method previously described and to an embodiment using a central controller and a number of agent terminals.

### BRIEF DESCRPTION OF THE DRAWINGS

FIG. 1 is a block diagram of the overall system FIG. 2 is a block diagram of the central controller.

FIG. 2A is an alternative block diagram of the central controller.

FIG. 3 is a block diagram of the agent terminal.

FIG. 4 is a flow chart illustrating an exemplary process by which an individual may obtain Family Protector Insurance.

FIG. 5 is a flow chart illustrating a first alternative process by which an individual may obtain Family Protector Insurance.

FIG. 6 is a flow chart illustrating a second alternative process by which an individual may obtain Family Protector Insurance.

FIG. 7 is a flow chart illustrating a third alternative process by which an individual may obtain Family Protector Insurance.

FIG. 8 is a flow chart illustrating a fourth alternative process by which an individual may obtain Family Protector Insurance.

### DETAILED DESCRIPTION OF THE INVENTION

The present invention is directed to a method, apparatus and system for pricing and selling Family Protector Insurance.

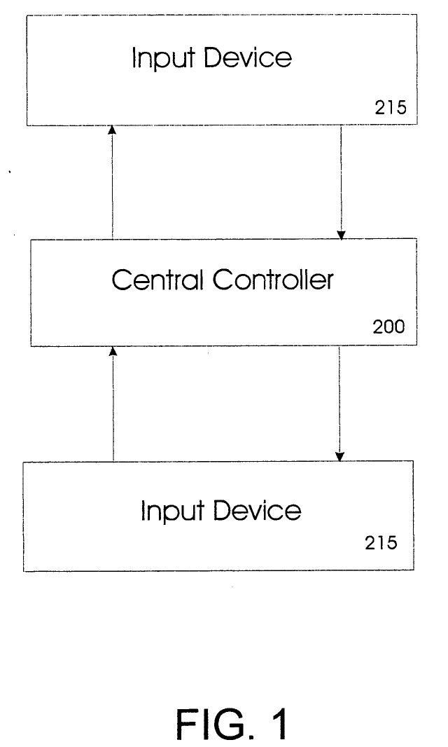

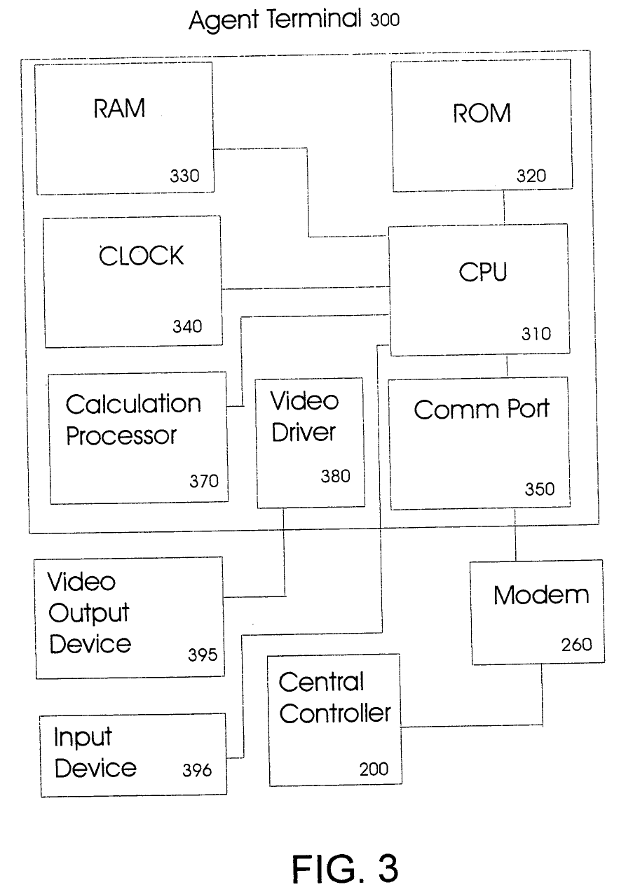

The mechanics of Family Protector Disability Insurance are set forth in FIG. 1. FIG. 1 is an overall system block diagram of the present invention. In this embodiment the central controller 200 is linked to at least one input device 215. Two input devices are depicted in FIG. 1, but it will be readily understood by those skilled in the art that any number of input devices may be used. A transaction can be initiated from any one of the input devices 215. The information required to implement the transaction is passed between the input device 215 and the central controller 200, until the transaction is complete. The central controller 200 keeps track of all transactions. The input device 215 may be an agent terminal 300 (described infra in FIG. 3), a keyboard, voice recognition system or other input device capable of conveying information from the user to the central controller 200.

The system depicted in FIG. 1 may be embodied in hardware specifically provided to implement the present invention. Alternatively, the system may be implemented using the infrastructure that already links insurers to insurance agents, and/or the links already in place between an insurers server and private individuals.

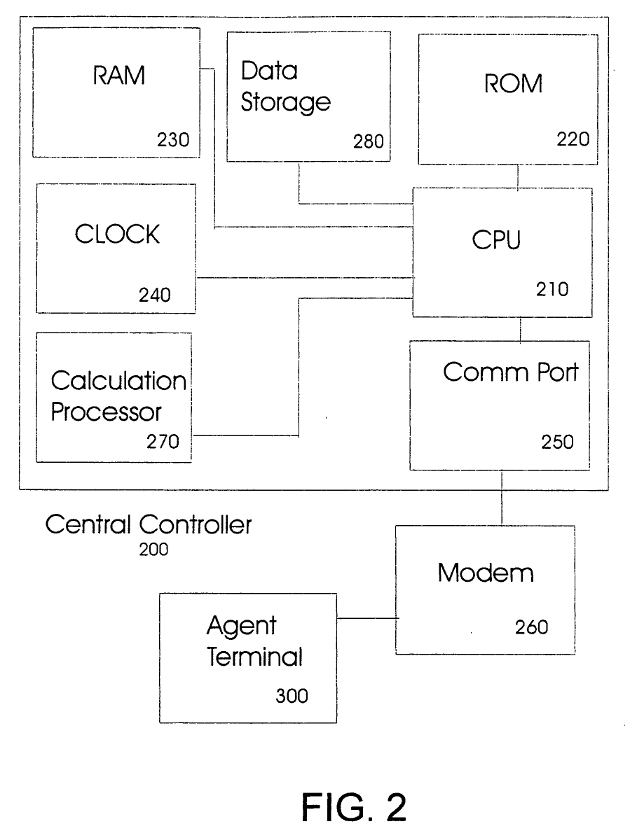

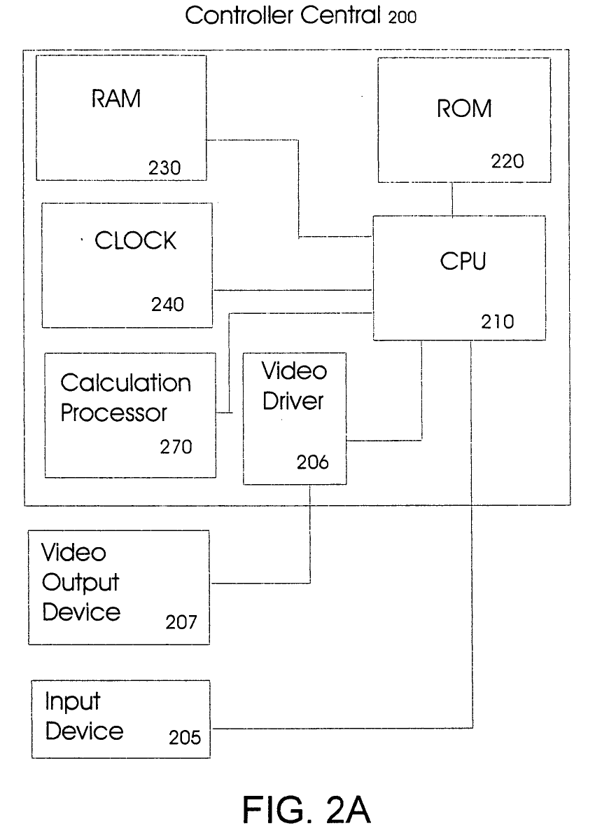

FIG. 2 is a block diagram of a central controller 200. The central controller includes a CPU 210, which is responsible for performing the processing functions of the central controller 200. The central controller 200 also includes a Read Only Memory 220 (ROM) and a Random Access Memory 230 (RAM). The ROM 220 is used to store at least some of the program instructions that are to be executed by the CPU 210, such as portions of the operating system or BIOS, and the RAM 230 is used for temporary storage of data. A clock circuit 240 provides a clock signal that is required by the CPU 210 in order to adequately perform its functions. The central controller 200 may also include a calculation processor 270 that is connected to the CPU 210. The use of a CPU 210 in conjunction with ROM 220, RAM 230, and a clock circuit 240 should be well known to those skilled in the art of computer hardware design.

The central controller 200 also includes a communications port 250 that enables the CPU 210 to communicate with external devices, such as an agent terminal, 300. The communications port 250 enables communication between external devices and the CPU 260 through the modem 260.

It should be noted that while the illustrated embodiment depicted in FIG. 2 uses a modem 260 to communicate with remote devices, it should be readily known and well understood to those educated in the art that other methods of communicating with remote devices may be used instead of, or in conjunction with, a modem.

The CPU 210 can also store information to, and read information from, the data storage device 280.

FIG. 2A is an alternative embodiment of a central controller 200. FIG. 2A depicts an input device, 205, that is connected directly to the CPU 210 of the central controller. This input device may be a keyboard, voice recognition system or other device capable of communicating information from the user to the central controller. Additionally, FIG. 2A depicts a Video Output Device 207, which is connected to the CPU 210 through a Video Driver 206.

FIG. 3 is a block diagram of an agent terminal 300, which can be located at any number of locations, including an insurers' place of business, an insurance agency, or a private home, to name but a few places. There can be any number of agent terminals 300 linked up to one central controller 200. Like the central controller 200 described above, the agent terminal 300 includes a CPU 310, ROM 320, RAM 330, and a clock circuit 340. The agent terminal 300 also includes a communications port 350 that connects to a modem 360, or other communications device, to enable communication between the agent terminal 300 and the central controller 200.

It is also possible for either an IBM compatible personal computer or an Apple Macintosh computer to be used as the agent terminal. Alternatively, a dedicated, stand-alone agent terminal may be used.

The agent terminal 300 also includes an input device 400 to receive input from an operator. Any of a wide variety of input devices would be suitable for this purpose, including but not limited to, keyboards, mice, touch screens, laser pens, voice activated systems and other similar input devices. The input device 396 can interface directly with the CPU 310. Alternatively, an appropriate interface circuit may be placed between the CPU 310 and the input device 395.

The agent terminal 300 also includes a video output device 390 for conveying information to the operator. The preferred embodiment of the video output device is a computer monitor, however, there are certainly a number of other appropriate video output devices that are capable of visually conveying the necessary information to the operator. A video driver 380 is also necessary to enable the CPU 310 to connect with the video output device 390.

The agent terminal 300 also includes a data storage device 370, in which the calculation processor instructions 375 are stored. These instructions can be read by and executed by the CPU 310, thus enabling the CPU 310 to process transactions.

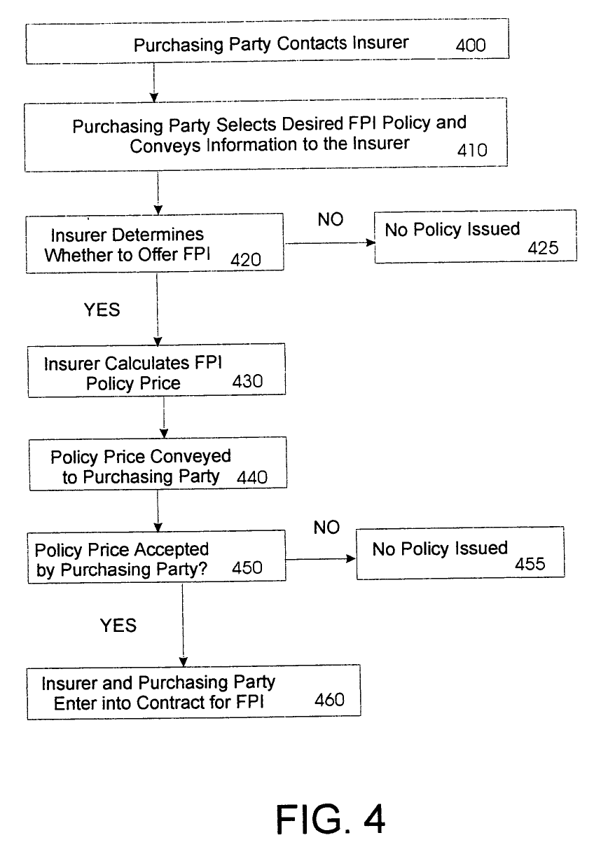

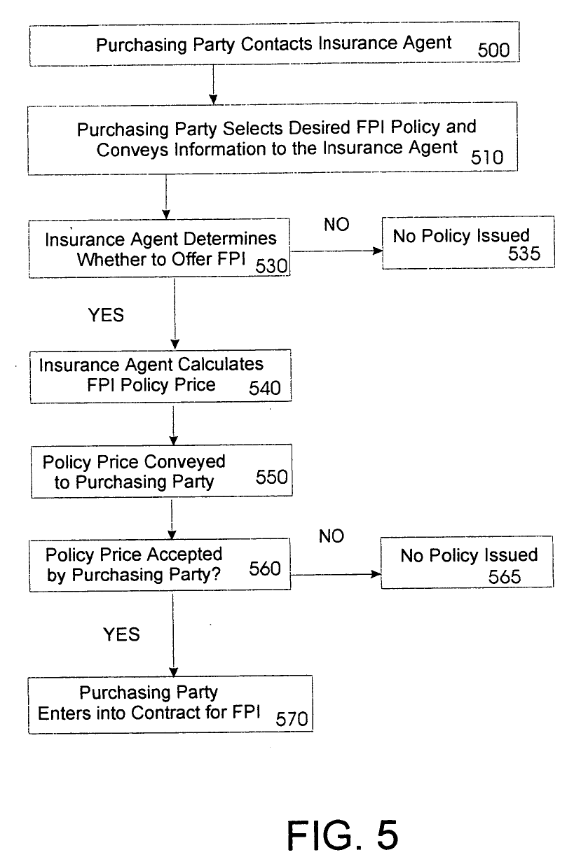

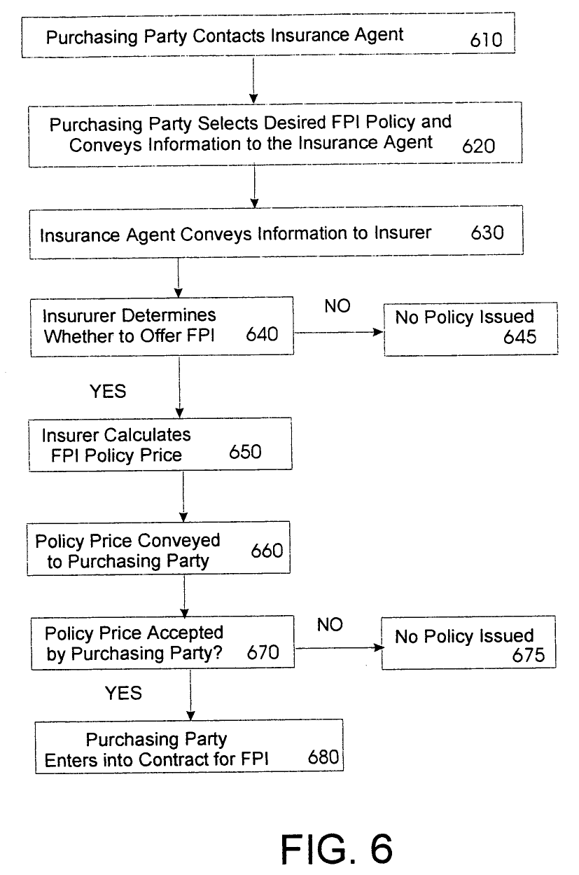

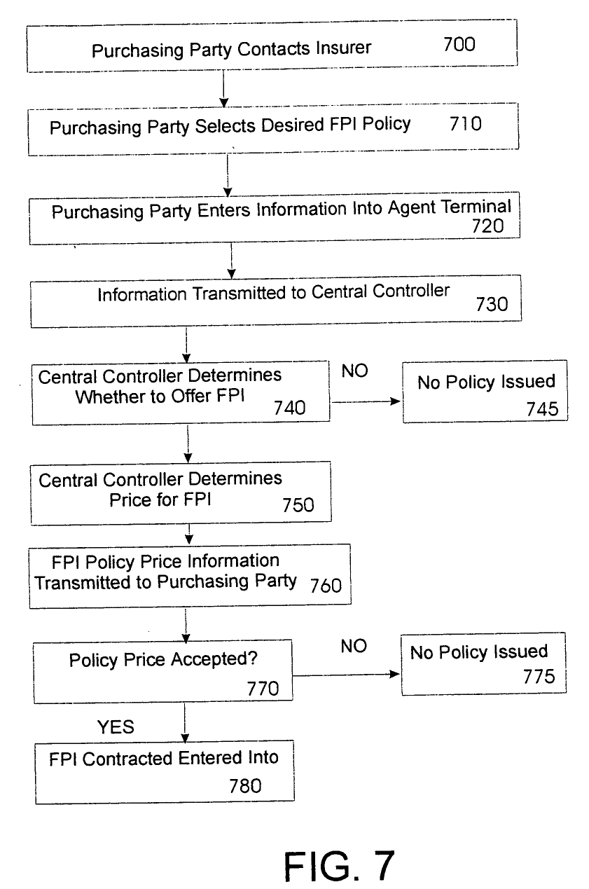

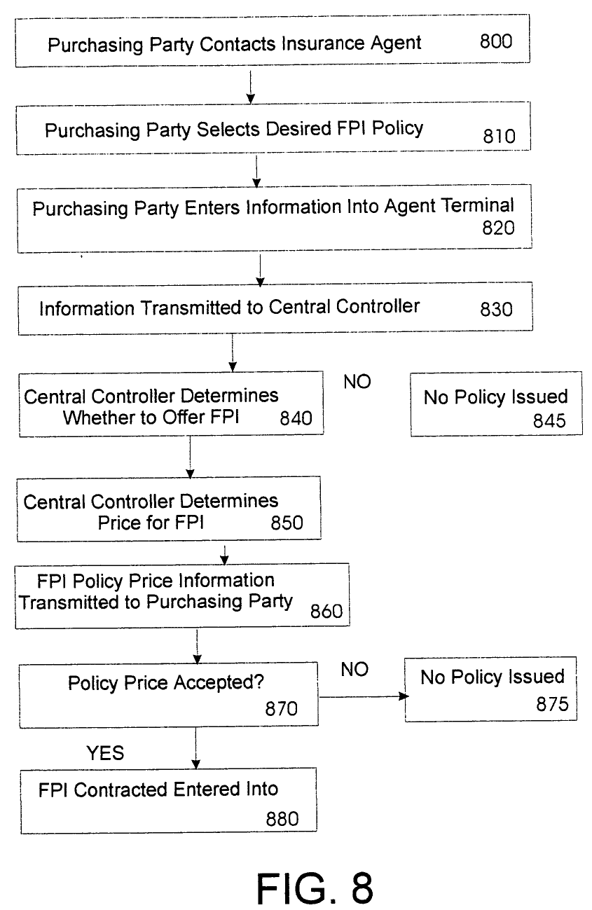

FIG. 4 is a flow chart depicting the transaction between the party interested in purchasing Family Protector Insurance (i.e., the purchasing party) and the insurer. The steps show in FIG. 4 may, but need not, be implemented through the use of a computer network. Similarly, with respect to other embodiments of the present invention, specifically but not limited to those embodiments described in FIG. 4, FIG. 5 (infra), FIG. 6 (infra), FIG. 7 (infra) and FIG. 8 (infra), it is also possible, but not necessary, to implement the invention through the use of a computer network. It should be noted that the preferred embodiment of a computer network is the global medium of communication commonly referred to as the Internet. In these embodiments, the party interested in purchasing the Family Protector Insurance inputs the relevant information into a computer or agent terminal and transmits the information to the insurer through the Internet. It should be readily apparent, however, that transmission and receipt of information may also be accomplished through a stand alone computer network, which may or may not be connected to the Internet.

At the outset, the party interested in purchasing the Family Protector Insurance contacts an insurer offering that insurance policy, 400.

For purposes of this invention generally, and specifically for purposes of the embodiments described in FIG. 4, FIG. 5 (infra), FIG. 6 (infra), FIG. 7 (infra) and FIG. 8 (infra), the person interested in purchasing the Family Protector Insurance can be either the payor spouse or the payee spouse. It should be obvious to one skilled in the art that the party interested in purchasing the Family Protector Insurance may do so through and an agent, such as legal counsel, a business advisor, personal representative and/or a fiduciary. Likewise, it should also be apparent that this transaction could be directed to be initiated at the order of a court, as a part of a some court order or divorce decree. The fact that an intermediary is used in purchasing or inquiring about the Family Protector Insurance does not change or alter the invention; the party interested in purchasing the Family Protector Insurance stays the same. Likewise, the fact that a court orders a party to purchase Family Protector insurance does not change the invention or alter the fact that it is the interested party actually seeking and purchasing the insurance policy. Moreover, it should also be apparent that this transaction could be initiated at the time the divorce is finalized, at the time any child support payments are ordered, or at any time subsequent.

After the party interested in purchasing the Family Protector Insurance makes the initial contact, 400, the purchasing party will select the desired policy and convey information to the insurer, 410. As a result of the information conveyed to the insurer a decision will be made whether to offer a policy, 420. The insurer can either decline to issue a policy, in which case no policy will issue, 425, or the insurer can decide to offer a policy. If the insurer decides to offer a policy the insurer will calculate the policy price, 430. After the policy price is calculated it will be conveyed to the purchasing party, 440. The purchasing party then has the option to accept or deny the policy, 450, at least in so far as the insurer is concerned. It will be obvious to those skilled in the art that if an individual is under an order of the court to obtain Family Protector Insurance, that individual does not have the option not to obtain such insurance, but rather the decision discussed of here is the decision whether to accept or deny a particular policy offered by a particular insurance agent. If the purchasing party does not agree to the policy price no policy is issued, 455. If the purchasing party agrees to the policy price the insurer and the purchasing party enter into a contract for Family Protector Insurance, 460.

FIG. 5 is a flow chart depicting the initiation of a transaction between the party interested in purchasing Family Protector Insurance (i.e., the purchasing party) and an insurance agent. The steps show in FIG. 5 may, but need not, be implemented through the use of a computer program and/or network.

At the outset, the party interested in purchasing the Family Protector Insurance contacts an insurance agent, 500. After the party interested in purchasing the Family Protector Insurance makes the initial contact, 500, the purchasing party will select the desired policy and convey information to the insurance agent, 510. The insurance agent will then determine whether to offer Family Protector Insurance, 530. The insurance agent can either decline to issue a policy, in which case no policy will issue, 535, or the insurance agent can decide to offer a policy. If the insurance agent decides to offer a policy the insurer will calculate the policy price, 540. After the policy price is calculated it will be conveyed to the purchasing party, 550. The purchasing party then has the option to accept or deny the policy, 560, at least in so far as the insurance agent is concerned. It will be obvious to those skilled in the art that if an individual is under an order of the court to obtain Family Protector Insurance, that individual does not have the option not to obtain such insurance, but rather the decision discussed of here is the decision whether accept or deny a particular policy offered by a particular insurance agent. If the purchasing party does not agree to the policy price no policy is issued, 565. If the purchasing party agrees to the policy price the insurer and the purchasing party enter into a contract for Family Protector Insurance, 570.

FIG. 6 is a flow chart depicting the initiation of a transaction between the party interested in purchasing Family Protector Insurance (i.e., the purchasing party) and an insurance agent. The steps show in FIG. 6 may, but need not, be implemented through the use of a computer program and/or network.

At the outset, the party interested in purchasing the Family Protector Insurance contacts an insurance agent, 610. After the party interested in purchasing the Family Protector Insurance makes the initial contact, 610, the purchasing party will select the desired policy and convey information to the insurance agent, 620. The insurance agent will then convey the information of the purchasing party to the insurer, 630. The insurer will then determine whether to offer Family Protector Insurance, 640. The insurer can either decline to issue a policy, in which case no policy will issue, 645, or the insurance agent can decide to offer a policy. If the insurance agent decides to offer a policy the insurer will calculate the policy price, 650. After the policy price is calculated it will be conveyed to the purchasing party, 660. The purchasing party then has the option to accept or deny the policy, 670, at least in so far as the insurer is concerned. It will be obvious to those skilled in the art that if an individual is under an order of the court to obtain Family Protector Insurance, that individual does not have the option not to obtain such insurance, but rather the decision discussed of here is the decision whether accept or deny a particular policy offered by a particular insurance agent. If the purchasing party does not agree to the policy price no policy is issued, 675. If the purchasing party agrees to the policy price the insurer and the purchasing party enter into a contract for Family Protector Insurance, 680.

FIG. 7 is a flow chart depicting the initiation of a transaction between the party interested in purchasing Family Protector Insurance (i.e., the purchasing party) and an insurer.

At the outset, the party interested in purchasing the Family Protector Insurance contacts an insurer, 700. After the party interested in purchasing the Family Protector Insurance makes the initial contact, 700, the purchasing party will select the desired policy, 710, and will enter, or have entered on their behalf, information into an agent terminal, 720. The information entered will then be transmitted to a central controller, 730. The central controller will process the information and determine whether to offer Family Protector Insurance, 740. The central controller will either determine not to issue a policy, in which case no policy will issue, 745, or the central controller will determine to offer a policy. If the central controller determines that a policy should be offered a price will be calculated for the policy, 750. After the policy price is calculated it will be transmitted to the purchasing party, 760. The purchasing party then has the option to accept or deny the policy, 770, at least in so far as the insurer is concerned. It will be obvious to those skilled in the art that if an individual is under an order of the court to obtain Family Protector Insurance, that individual does not have the option not to obtain such insurance, but rather the decision discussed of here is the decision whether accept or deny a particular policy offered by a particular insurance agent. If the purchasing party does not agree to the policy price no policy is issued, 775. If the purchasing party agrees to the policy price the insurer and the purchasing party enter into a contract for Family Protector Insurance, 780.

FIG. 8 is a flow chart depicting the initiation of a transaction between the party interested in purchasing Family Protector Insurance (i.e., the purchasing party) and an insurer.

At the outset, the party interested in purchasing the Family Protector Insurance contacts an insurance agent, 800. After the party interested in purchasing the Family Protector Insurance makes the initial contact, 800, the purchasing party will select the desired policy, 810, and will enter, or have entered on their behalf, information into an agent terminal, 820.

Once entered, the information will then be transmitted to a central controller, 830. The central controller will process the information and determine whether to offer Family Protector Insurance, 840. The central controller will either determine not to issue a policy, in which case no policy will issue, 845, or the central controller will determine to offer a policy. If the central controller determines that a policy should be offered a price will be calculated for the policy, 850. After the policy price is calculated it will be transmitted to the purchasing party, 860. The purchasing party then has the option to accept or deny the policy, 870, at least in so far as the insurer is concerned. It will be obvious to those skilled in the art that if an individual is under an order of the court to obtain Family Protector Insurance, that individual does not have the option not to obtain such insurance, but rather the decision discussed of here is the decision whether accept or deny a particular policy offered by a particular insurance agent. If the purchasing party does not agree to the policy price no policy is issued, 875. If the purchasing party agrees to the policy price the insurer and the purchasing party enter into a contract for Family Protector Insurance, 880.

While the present invention has been described above in terms of specific embodiments, it is to be understood that the invention is not limited to the disclosed embodiments. To the contrary, the present invention is intended to cover various modifications and equivalent structures and methods included within the spirit and scope of the appended claims.

1. A method for pricing and selling Family Protector Insurance comprising:
receiving information relative to the proposed purchase of Family Protector Insurance;
determining the price of the Family Protector Insurance;
conveying the price and policy terms to the party interested in purchasing Family Protector Insurance.

2. The method of claim 1, wherein the step of receiving information includes receiving name and social security number.

3. The method of claim 1, wherein the step of receiving information includes receiving a copy of the court ordered divorce decree.

4. The method of claim 1, wherein the step of receiving information includes receiving a copy of the court order containing the child support award.

5. The method of claim 1, wherein the step of receiving information includes receiving a copy of the court ordered alimony award.

6. The method of claim 1, further comprising the step of inputting the information into a computer or agent terminal.

7. The method of claim 1, further comprising the step of inputting the information into a computer or agent terminal and of conveying the information to the insurer via computer network.

8. The method of claim 1, wherein the step of receiving information relative to the proposed purchase of Family Protector Insurance is accomplished by receiving the information via a computer network.

9. The method of claim 1, further comprising the steps of conveying information to the insured.

10. The method of claim 1, further comprising the steps of conveying information to the insured wherein the step of conveying the information to the insurer includes conveying the information via computer network.

11. The method of claim 1, wherein the step of receiving information relative to the proposed purchase of Family Protector Insurance is accomplished by an insurance agent obtaining the information from the party interested in purchasing the Family Protector Insurance.

12. The method of claim 1, wherein the step of determining is accomplished by a computer program calculating the price based upon the information received.

13. The method of claim 1, wherein the step of conveying the purchase price is accomplished by conveying the purchase price to the party interested in purchasing Family Protector Insurance through a computer network.

14. The methods of claims 1, further comprising the step of receiving a request to purchase Family protector Insurance.

15. A data processing apparatus for determining a price for Family Protector Insurance comprising:
a central controller having a CPU and a memory operatively connected to the CPU;
at least one terminal connected to the central controller that is adapted for communicating with the central controller;
the memory in the central controller containing a program, adapted to be executed by the CPU, for determining a price for Family Protector Insurance based upon information received by the central controller.

16. The apparatus of claim 15, wherein the program in the memory is adapted to receive a request to purchase Family Protector Insurance.

17. The apparatus of claim 15, wherein the program in the memory is adapted to receive a request to purchase Family Protector Insurance and where the program is further adapted to perform a credit card transaction to purchase the insurance to the purchasing party.

18. A data processing apparatus for selling Family Protector Insurance comprising a terminal adapted to communicate with a central controller that calculates a price of the Family Protector Insurance.
